(19) United States
(12) Patent Application Publication
(10) Pub. No.: US 2003/0074093 A1
(43) Pub. Date: Apr. 17, 2003

(54) Digital encoding and/or conversion

(75) Inventor: Caesar Collazo, Marina del Rey, CA (US)

Correspondence Address: SOCAL IP LAW GROUP, 310 N. WESTLAKE BLVD. STE 120, WESTLAKE VILLAGE, CA, 91362, US

(73) Assignee: Media & Entertainment.com, Inc., Burbank, CA

(21) Appl. No.: 10/256,556

(22) Filed: Sep. 26, 2002

Related U.S. Application Data
(60) Provisional application No. 60/324,870, filed on Sep. 26, 2001.

(51) Int. Cl. G06F 17/00; H04H 5/00

(52) U.S. Cl. 700/94; 381/2

(57) ABSTRACT

There is disclosed methods and apparatus for is for high quality, multimedia broadcast networks. Highly scalable, fault tolerant, filly integrated scheduled live video streaming are enabled or facilitated. A disclosed solution offers easy access, a convenient web-based remote management console and a flexible structure.

### RELATED APPLICATION INFORMATION

This application claims priority from Application No. 60/324,870 filed Sep. 26, 2001, which application is incorporated herein by reference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGROUND OF THE INVENTION

### Field of the Invention

The present invention relates to multimedia broadcast networks.

### DESCRIPTION OF THE DRAWINGS

The present invention will be described by way of exemplary embodiments, but not limitations, illustrated in the accompanying drawings in which like references denote similar elements.

FIG. 1 is a data flow diagram in accordance with the invention.

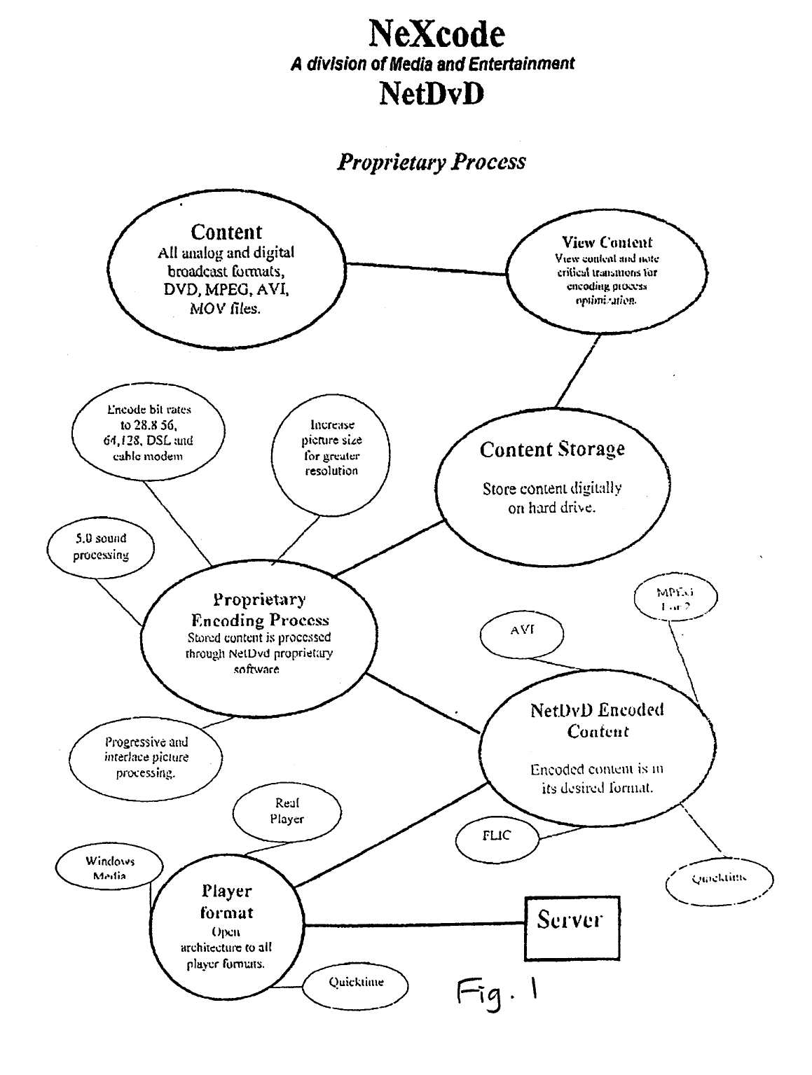

FIG. 2 is a block diagram of a system in accordance with the invention.

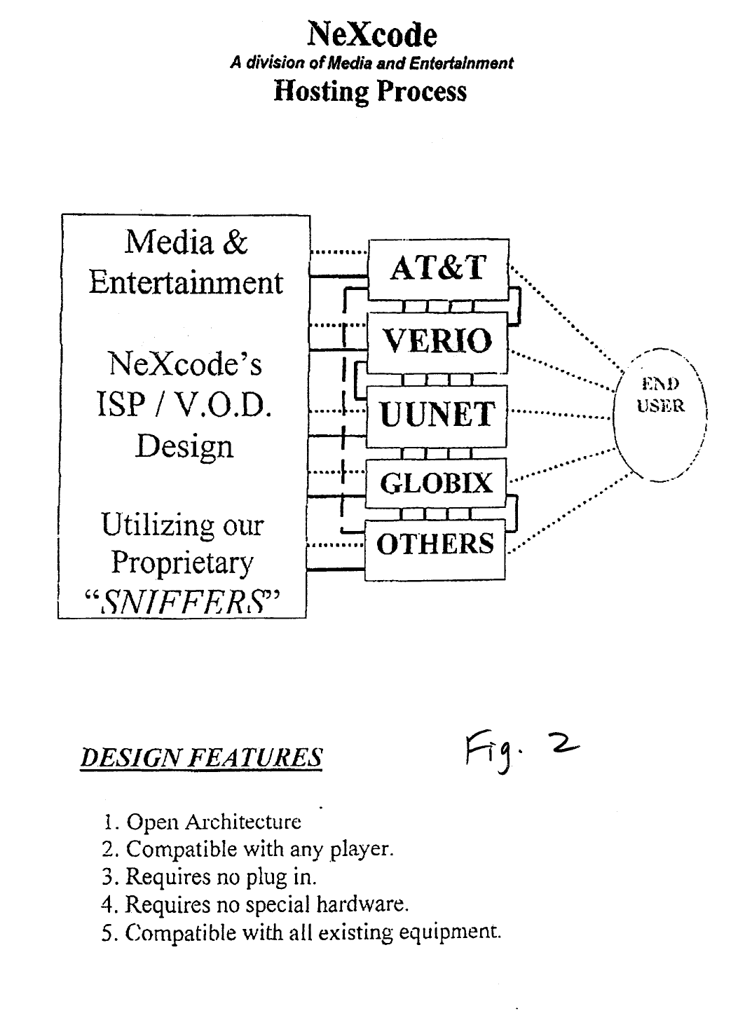

### DETAILED DESCRIPTION OF THE INVENTION

Throughout this description, the embodiments and examples shown should be considered as exemplars, rather than limitations on the apparatus and methods of the present invention.

NetDVD is for high quality, multimedia broadcast networks. It facilitates or enables highly scalable, fault tolerant, filly integrated scheduled live video streaming. This high-performance solution offers easy access, a convention web-based remote management console and a flexible structure. Above all, NetDVD provides broadcasters with a secure solution to stream content from source to client.

The NetDVD encoding method is comprised by a hybrid MPEG codec to initially covert video object files (VOB) to an Internet streamable format for programs such as Real Player, Windows Media Player, QuickTime or any other video streaming technology that has the capabilities of converting audio-video interleave files (AVI). On particular feature of the invention is that the scalability and compression of an MPEG encoded file keeps up to 89% of the VOB output in its true 16:9 theatrical format, or 4:3 aspect ratio, as well as maintaining a full high-fidelity surround sound quality.

Other features of the invention include:

(1) Live and schedule multicasts and broadcasts to thousands of viewers using a single stream of network bandwidth.

(2) Intelligent scheduling systems capable of multi-channel program guides.

(3) Web-based remote and local console.

(4) Encoding up to 30 frames per second.

(5) Video and audio delivery based on industry standard formats including MPEG-1, MPEG-2, MP3 and ASF compression standards.

(6) Up to 7 concurrent audio and video channels per server.

(7) High resolution, full-motion video quality.

NetDVD has a more extensible open architecture that facilitates c-commerce with:

(1) ODBC connectivity

(2) Java-based remote management

(3) Multiple access to warehoused distributed video

(4) Media resource management among repositories

(5) Bandwidth support from 28.8 kb/s to 16 Mb/s

(6) Up to 1000 simultaneous high quality streams per server

(7) Load balancing between multiple servers, network cards and processors.

NetDVD—Step By Step Encoding Process

1. The first phase of the process is to use the JPEG file compression on the footage. The JPEG format supports 24-bt color and preserves the broad range of subtle variations and hue found in each continuous-toned frame. JPEG compresses the file size by selectively discarding data. Because it discards data, this compression is referred to as “lossy.”

The higher quality setting results in less data being discarded, and a lower quality setting in the compression method can degrade sharp details in the frame. Artifacts, such as wave-like patterns or blocky areas of banding are added to the frame.

2. The second phase of the NetDVD method is to adjust the palette. Palettes help you monitor and modify frame images. A palette displays information about the color values per frame. The inventor has found in research that if a string of images could be reduced to a set number of color values per second, this would be the first step in reducing file size.

For example, 3 seconds of footage at 24 frames per second result in 72 frames in length.

3. The third phase of the NetDVD process splits the audio into two channels and preserves the surround or Dolby effect within the footage.

For example, Dolby 5.1 surround is a .ac3 file format, so you must overlay the rear left on top of the left front with a delay in milliseconds. Then the center is an overlay on top of the same left front channel with a delay in milliseconds as follows:

a. Left audio track=RL LF C

b. Right audio track=C RF RR

c. Schematic speaker sound

d. RL LF C RF RR

These steps allow the preservation of the original 5.1 sound in a 48 or 44.1 kHz PCM audio format that now is converted to the MPEG3 format.

4. The fourth and final phase of the NetDVD process handles interleaving of both the footage frames and the MPEG3 audio files together in order to have a proprietary video format. Inserting one sound byte to every frame of footage does this. The output will no longer be in MPEG 1 or 2. It is a hybrid of the MPEG format which means that it can be saved as any video file format, such as .avi, .flc, .flm or .mov.

It should be noted that since the computer that created the “new” file is the one that can view the footage file, it will be necessary to establish the delivery vehicle of choice, so that others can view the footage file. These delivery vehicles are called “encoders.” These encoders may be specifically designed to take our footage and process it for sharing. There are many types of encoders on the market, but encoders for the Internet are the most popular ones. The players include but are not limited to the following: Windows Media Player, Real Player, Apple QuickTime.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications and alterations should therefore be seen as within the scope of the present invention.

It is claimed:

1. A method of processing audio/video content comprising:
providing footage comprising plural frames
providing audio in digital format comprising plural bytes
compressing the footage, wherein the footage has a palette
adjusting the palette
splitting the audio into two channels, whereby multi-channel or surround effect are preserved
interleaving the footage and the audio by inserting byte of audio to every frame of footage.
